(19) United States
(12) Patent Application Publication
(10) Pub. No.: US 2017/0221358 A1
(43) Pub. Date: Aug. 3, 2017

(54) SIGNAL PASSING SUPPORT APPARATUS

(71) Applicant: TOYOTA JIDOSHA KABUSHIKI KAISHA, Toyota-shi (JP)

(72) Inventor: Yasunari KIDO, Hadano-shi (JP)

(73) Assignee: TOYOTA JIDOSHA KABUSHIKI KAISHA, Toyota-shi (JP)

(21) Appl. No.: 15/412,180

(22) Filed: Jan. 23, 2017

(30) Foreign Application Priority Data
Feb. 2, 2016 (JP) 2016-017830

(51) Int. Cl. G08G 1/0967; B60W 30/18; B60W 50/14; G08G 1/08; B60W 40/105

(52) U.S. Cl. CPC G08G 1/0967; G08G 1/08; B60W 40/105; B60W 50/14; B60W 30/18154; B60W 2750/40; B60W 2520/10; B60W 2550/22; B60W 2050/146

(57) ABSTRACT

A signal passing support apparatus includes: a providing device provides support information for supporting a vehicle to pass through a traffic signal to a driver, and a determining device that determines whether or not a vehicle speed is larger than a first reference speed and is smaller than a second reference speed, the providing device starts the providing of the support information when it is determined that the vehicle speed is larger than the first reference speed when the providing device does not provide the support information, and the providing device terminates the providing of the support information when the vehicle speed is smaller than the second reference speed when the providing device provides the support information.

### CROSS-REFERENCE TO RELATED APPLICATIONS

This application claims priority from Japanese Patent Application No. 2016-017830 filed on Feb. 2, 2016, the disclosure of which, including the specification, drawings and abstract is incorporated herein by reference in its entirety.

### BACKGROUND

1. Technical Field

The present disclosure relates to a signal passing support apparatus that is configured to support a vehicle to pass through a traffic signal, for example.

2. Description of Related Art

A signal passing support apparatus that is configured to provide or inform a driver in a vehicle of support information for supporting the vehicle to pass through a traffic signal is known. For example, Japanese Unexamined Patent Application Publication No. 2012-203785 discloses a signal passing support apparatus that is configured to provide the support information when it is determined that an intersection having the traffic signal is an intersection through which the vehicle is allowed to pass without stopping, wherein the support information indicates a range of vehicle speed by which the intersection becomes a passable intersection and/or indicates that the intersection is not the passable intersection.

When the vehicle runs (moves or travels) at a low speed, there is a high possibility that the driver does not intend to pass through the traffic signal. Therefore, if the support information is provided even in this case, there is a possibility that the supporting information may annoy the driver. Thus, as a method of reducing the annoyance of the driver, a controlling method of not providing the support information to the driver when the vehicle speed is smaller than a predetermined speed and providing the support information to the driver when the vehicle speed is larger than the predetermined speed is anticipated.

Here, if the predetermined speed is set to be a relatively large speed, the support information is less likely to be provided when the vehicle speed is relatively small, compared to the case where the predetermined speed is set to be a relatively small speed. Thus, the annoyance of the driver can be reduced. On the other hand, the support information is less likely to be provided, because it is less likely to be determined that the vehicle speed is larger than the predetermined speed. As a result, the signal passing support apparatus may have less opportunity to provide the support information.

On the other hand, if the predetermined speed is set to be the relatively small speed, it is more likely to be determined that the vehicle speed is larger than the predetermined speed, compared to the case where the predetermined speed is set to be the relatively large speed. Therefore, the signal passing support apparatus may have more opportunity to provide the support information, because the support information is more likely to be provided. On the other hand, the support information is more likely to be provided even when the vehicle speed is relatively small, because it is less likely to be determined that the vehicle speed is smaller than the predetermined speed. Namely, the support information is more likely to be provided when the vehicle speed is small to an extent at which the driver does not intend to pass through the traffic signal although the vehicle speed is not smaller than the predetermined speed. Therefore, the annoyance of the driver cannot be reduced.

As described above, according to the controlling method of not providing the support information when the vehicle speed is smaller than the predetermined speed and providing the support information when the vehicle speed is larger than the predetermined speed, it is difficult for the signal passing support apparatus to appropriately secure the opportunity to provide the support information while reducing the annoyance of the driver that is caused by providing the support information.

The present disclosure is intended to provide a signal passing support apparatus that is capable of appropriately securing the opportunity to provide the support information while reducing the annoyance of the driver that is caused by the providing of the support information.

### SUMMARY

A signal passing support apparatus is provided with: an informing device that is configured to provide support information of a driver of a vehicle, the supporting information being for supporting the vehicle to pass through a traffic signal; and a determining device that is configured to determine whether or not a vehicle speed of the vehicle is larger than a first reference speed and the vehicle speed is smaller than a second reference speed, the second reference speed being smaller than the first reference speed, wherein the providing device is configured to start the providing of the support information when it is determined that the vehicle speed is larger than the first reference speed under a situation where the providing device does not provide the support information, the providing device is configured to terminate the providing of the support information when it is determined that the vehicle speed is smaller than the second reference speed under a situation where the providing device provides the support information.

According to the signal passing support apparatus, the first reference speed that is compared with the vehicle speed to determine whether to start the providing of the support information and the second reference speed that is compared with the vehicle speed to determine whether to terminate the providing of the support information are used separately. Thus, as described later in detail with reference to the drawings, the signal passing support apparatus is capable of appropriately securing the opportunity to provide the support information while reducing the annoyance of the driver that is caused by the providing of the support information, compared to a signal passing support apparatus in a comparison example in which a threshold value (for example, a reference speed) that is compared with the vehicle speed to determine whether to start the providing of the support information is same as a threshold value (for example, a reference speed) that is compared with the vehicle speed to determine whether to terminate the providing of the support information.

In another aspect of the signal passing support apparatus, the providing device is configured not to provide the support information when it is determined that the vehicle speed is not larger than the first reference speed under the situation where the providing device does not provide the support information, the providing device is configured to keep providing the support information when it is determined that the vehicle speed is not smaller than the second reference speed under the situation where the providing device provides the support information.

According to this aspect, the providing device that is not providing the support information does not start the providing of the support information until it is determined that the vehicle speed is larger than the first reference speed. On the other hand, the providing device that is providing the support information does not terminate the providing of the support information until it is determined that the vehicle speed is smaller than the second reference speed. Therefore, as described below with reference to the drawings, the signal passing support apparatus is capable of appropriately securing the opportunity to provide the support information while reducing the annoyance of the driver that is caused by providing the support information

In another aspect of the signal passing support apparatus, the signal passing support apparatus is further provided with a generating device that is configured to generate the support information during a period when the providing device provides the support information and that is configured not to generate the support information during a period when the providing device does not provide the support information.

According to this aspect, the generating device does not always generate the support information. Thus, a processing load of the signal passing support apparatus can be reduced.

In another aspect of the signal passing support apparatus, the generating device is configured to start the generation of the support information when it is determined that the vehicle speed is larger than the first reference speed under the situation where the providing device does not provide the support information, the generating device is configured to terminate the generation of the support information when it is determined that the vehicle speed is smaller than the second reference speed under the situation where the providing device provides the support information.

According to this aspect, the generating device is capable of starting the generation of the support information at a timing when the providing device starts providing the support information. Moreover, the generating device is capable of terminating the generation of the support information at a timing when the providing device terminates the providing of the support information.

In another aspect of the signal passing support apparatus, the generating device is configured not to generate the support information when it is determined that the vehicle speed is not larger than the first reference speed in response to the providing device not providing the support information, the generating device is configured to keep generating the support information when it is determined that the vehicle speed is not smaller than the second reference speed in response to the providing device providing the support information.

According to this aspect, the generating device is not allowed to generate the support information during a period when the providing device does not provide the support information and is allowed to generate the support information during a period when the information device provides the support information.

### BRIEF DESCRIPTION OF THE DRAWINGS

FIG. 1 is a block diagram that illustrates a structure of a vehicle in a present embodiment;

FIG. 2 is a flowchart that illustrates a flow of a signal passing support operation;

FIG. 3 is a timing chart that illustrates a vehicle speed and a support necessity flag that is set when a signal passing support operation in a first comparison example is performed;

FIG. 4 is a timing chart that illustrates a vehicle speed and a support necessity flag that is set when a signal passing support operation in a second comparison example is performed; and

FIG. 5 is a timing chart that illustrates a vehicle speed and support necessity flag that is set when the signal passing support operation in the present embodiment is performed.

### DETAILED DESCRIPTION OF EMBODIMENTS

Exemplary embodiments of the present disclosure, with reference to the drawings, are described in detail. Hereinafter, a vehicle 1 to which the signal passing support apparatus is applied will be explained. When certain parts, throughout the present invention, “includes” certain component factor, this description, unless otherwise specified, does not mean to exclude other component factors but intends to further include other component factors. Also, a term such as “ . . . unit”, “module”, etc. described in the present invention means an element executing at least one function or an operation, and may be realized as hardware, software, or a combination of hardware and software.

(1) Structure of Vehicle 1

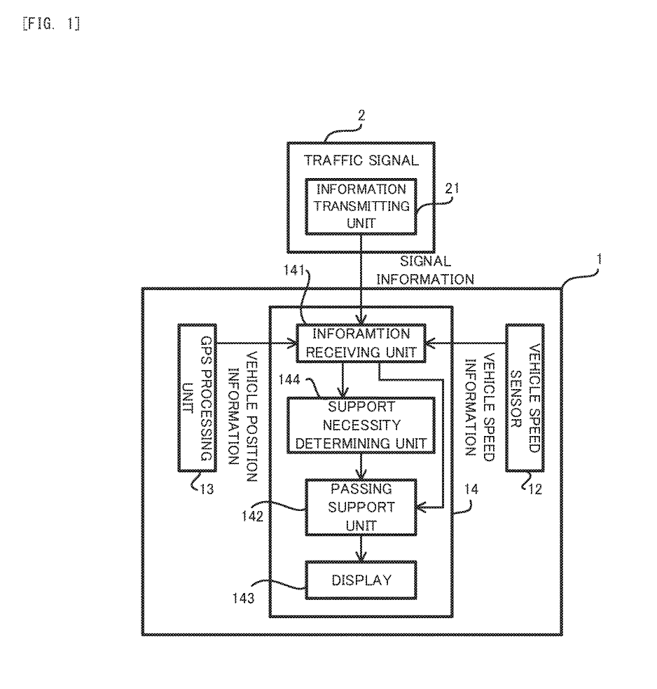

With reference to a block diagram in FIG. 1, a structure of the vehicle 1 in the present embodiment will be explained. As illustrated in FIG. 1, the vehicle 1 is provided with: a vehicle speed sensor 12; a GPS (Global Positioning System) processing unit 13; and a signal passing support apparatus 14.

The vehicle speed sensor 12 is configured to detect a velocity (a vehicle speed) V of the vehicle 1. A vehicle speed information (the vehicle speed V) that indicates a detection result of the vehicle speed sensor 12 is outputted to the signal passing support apparatus 14.

The GPS processing unit 13 is configured to receive GPS radio wave that is transmitted from a GPS satellite. The GPS processing unit 13 is configured to calculate a current position of the vehicle 1 (hereinafter, referred to as a “vehicle position”) on the basis of the received GPS radio wave. A vehicle position information that indicates the vehicle position calculated by the GPS processing unit 13 is outputted to the signal passing support apparatus 14.

The signal passing support apparatus 14 performs a signal passing support operation that supports the vehicle 1 to pass through a traffic signal 2 that is located at a front side in a running direction (a moving direction or a traveling direction) of the vehicle 1 (namely, to pass through an intersection having the traffic signal 2). When a plurality of traffic signals 2 are located at the front side in the running direction of the vehicle 1, the signal passing support apparatus 14 performs the signal passing support operation that supports the vehicle 1 to pass through the traffic signal 2 that is closest to the vehicle 1 (namely, the traffic signal 2 that is located at an intersection through which the vehicle 1 passes first), as a general rule. Hereinafter, the “traffic signal 2” means the traffic signal 2 that is a target for the signal passing support operation, if there is no specific explanation.

In order to perform the signal passing support operation, the signal passing support apparatus 14 is provided with: an information receiving unit 141; a passing support unit 142 that is one example of the “generating device”; a display 143 that is one example of the “providing device” or an “informing device”; and a support necessity determining unit 144 that is one example of the “determining device”.

The information receiving unit 141 is configured to obtain the vehicle speed information that is the detection result of the vehicle speed sensor 12 and the vehicle position information that is a calculation result of the GPS processing unit 13. The information receiving unit 141 is configured to output the obtained vehicle speed information and vehicle position information to the passing support unit 142. The information receiving unit 141 is configured to output the obtained vehicle speed information to the support necessity determining unit 144.

The information receiving unit 141 is configured to further receive signal information that is information relating to the traffic signal 2. The information receiving unit 141 is configured to receive the signal information that is transmitted from an information transmitting unit 21 of the traffic signal 2. However, the information receiving unit 141 may be configured to receive the signal information from a server (alternatively, a repeater) that is configured to relay the information transmitted from the information transmitting unit 21 of the traffic signal 2. The information receiving unit 141 is configured to output the received signal information to the passing support unit 142.

The signal information includes signal position information that indicates a position of the traffic signal 2. The signal information further includes a timing information that indicates a timing (a time point) at which color of the traffic signal 2 changes. For example, the timing information is information that indicates a timing at which the color of the traffic signal 2 is changed from a first color (for example, red color) to a second color (for example, blue color), a timing at which the color of the traffic signal 2 is changed from the second color to third color (for example, yellow color) and a timing at which the color of the traffic signal 2 is changed from the third color to the first color, when the current color of the traffic signal 2 is the first color.

The passing support unit 142 is configured to generate a support information for supporting the vehicle 1 to pass through the traffic signal 2. Note that the passing support unit 142 is configured to generate the support information when the support necessity determining unit 144 determines that the display 143 should display the support information, as described later in detail. On the other hand, the passing support unit 142 is configured not to generate the support information when the support necessity determining unit 144 determines that the display 143 should not display the support information.

In order to generate the support information, the passing support unit 142 determines whether or not the vehicle 1 is capable of passing through the traffic signal 2 without stopping when the current vehicle speed V is maintained. Specifically, the passing support unit 142 calculates a distance between the vehicle 1 and the traffic signal 2 on the basis of the vehicle position information and the signal position information. Then, the passing support unit 142 calculates a time point t at which the vehicle 1 reaches the traffic signal 2 when the current vehicle speed V is maintained, on the basis of the vehicle speed V that is indicated by the vehicle speed information and the calculated distance. Then, the passing support unit 142 presumes the color of the traffic signal 2 at the time point t on the basis of the timing information and the calculated time point t. When the presumed color is the red color or the yellow color (alternatively, color that prohibits or limits the running of the vehicle 1), the passing support unit 142 determines that the vehicle 1 is not capable of passing through the traffic signal 2 without stopping. On the other hand, when the presumed color is the blue color (alternatively, color that allows the running of the vehicle 1), the passing support unit 142 determines that the vehicle 1 is capable of passing through the traffic signal 2 without stopping.

When it is determined that the vehicle 1 is capable of passing through the traffic signal 2 without stopping, the passing support unit 142 generates the supporting information for informing the driver that the current vehicle speed V allows the vehicle 1 to pass through the traffic signal 2 without stopping. When it is determined that the vehicle 1 is not capable of passing through the traffic signal 2 without stopping, the passing support unit 142 generates the supporting information for informing the driver that the current vehicle speed V does not allow the vehicle 1 to pass through the traffic signal 2 without stopping. Alternatively, when it is determined that the vehicle 1 is not capable of passing through the traffic signal 2 without stopping, the passing support unit 142 may generate the supporting information for providing the driver with the vehicle speed V (alternatively, a range of the vehicle speed V) that allows the vehicle 1 to pass through the traffic signal 2 without stopping. However, the support information may be any information that contributes the vehicle 1 to pass through the traffic signal 2.

The display 143 is configured to display the support information that is generated by the passing support unit 142. As a result, the driver of the vehicle 1 is allowed to recognize whether or not the vehicle 1 is capable of passing through the traffic signal 2 without stopping.

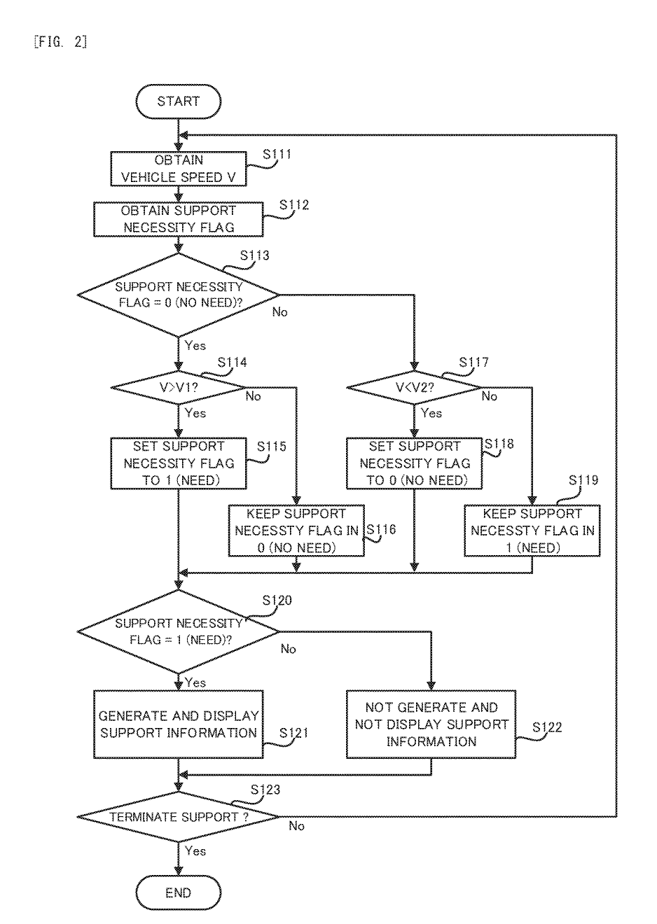

The support necessity determining unit 144 is configured to determine on the basis of the vehicle speed information whether or not the display 143 should display the support information (namely, the support information should be provided to the driver). When it is determined that the support information should be displayed, the display 143 displays the support information. When it is determined that the support information should not be displayed, the display 143 does not display the support information. An operation of the support necessity determining unit 144 will be explained later in detail (see FIG. 2).

Note that the passing support unit 142 generates the support information when the support necessity determining unit 144 determines that the display 143 should display the support information and the passing support unit 142 does not generate the support information when the support necessity determining unit 144 determines that the display 143 should not display the support information, as described above. Thus, it can be said that the support necessity determining unit 144 substantially determines whether or not the passing support unit 142 should generate the supporting information.

(2) Flow of Signal Passing Support Operation

Next, with reference to FIG. 2, the signal passing support operation performed by the signal passing support apparatus 14 will be explained. Note that the signal passing support apparatus 14 performs the signal passing support operation when an execution condition under which the signal passing support operation is allowed to be performed is satisfied. Any existing execution condition may be used. A condition where the distance between the vehicle 1 and the traffic signal 2 is equal to or larger than a predetermined distance is one example of the execution condition.

As illustrated in FIG. 2, the support necessity determining unit 144 obtains the vehicle speed information (namely, the current vehicle speed V) from the vehicle speed sensor 12 via the information receiving unit 141 (step S111).

Moreover, the support necessity determining unit 144 obtains a current support necessity flag (step S112). The support necessity flag is a flag that represents whether or not the display 143 should display the support information (moreover, a flag that substantially represents whether or not the passing support unit 142 should generate the support information). The support necessity flag becomes a flag that represents that the display 143 should display the support information (hereinafter, this flag is “1 (the support information is needed to be displayed)”, for example), when the support necessity determining unit 144 determines that the display 143 should display the support information. In this case, the display 143 displays the support information. On the other hand, the support necessity flag becomes a flag that represents that the display 143 should not display the support information (hereinafter, this flag is “0 (the support information is not needed to be displayed)”, for example), when the support necessity determining unit 144 determines that the display 143 should not display the support information. In this case, the display 143 does not display the support information. Note that an initial value of the support necessity flag (namely, a value that is represented by the support necessity flag when the signal passing support operation in FIG. 2 is performed first time) is 0.

Then, the support necessity determining unit 144 determines whether or not the current support necessity flag that is obtained at the step S112 is 0 (step S113). Namely, the support necessity determining unit 144 determines whether or not the display 143 is displaying the support information.

As a result of the determination at the step S113, when it is determined that the current support necessity flag is 0 (step S113: Yes), the display 143 is not currently displaying the support information. In this case, the support necessity determining unit 144 determines whether or not the current vehicle speed V that is obtained at the step S111 is larger than a first reference speed V1 (step S114).

As a result of the determination at the step S114, when it is determined that the current vehicle speed V is larger than the first reference speed V1 (step S114: Yes), the support necessity determining unit 144 determines that the display 143 should display the support information. Namely, the support necessity determining unit 144 determines that the display 143 should start to display the support information. Therefore, the support necessity determining unit 144 sets the support necessity flag to 1 (step S115). On the other hand, as a result of the determination at the step S114, when it is determined that the current vehicle speed V is not larger than the first reference speed V1 (step S114: No), the support necessity determining unit 144 determines that the display 143 should not still display the support information. Namely, the support necessity determining unit 144 determines that the display 143 should not start to display the support information. Therefore, the support necessity determining unit 144 keeps the support necessity flag in 0 (step S116).

On the other hand, as a result of the determination at the step S113, when it is determined that the current support necessity flag is not 0 (step S113: No), the display 143 is currently displaying the support information. In this case, the support necessity determining unit 144 determines whether or not the current vehicle speed V that is obtained at the step S111 is smaller than a second reference speed V2 (step S117). Note that the second reference speed V2 is smaller than the first reference speed V1.

As a result of the determination at the step S117, when it is determined that the current vehicle speed V is smaller than the second reference speed V2 (step S117: Yes), the support necessity determining unit 144 determines that the display 143 should not display the support information. Namely, the support necessity determining unit 144 determines that the display 143 should terminate the displaying of the support information. Therefore, the support necessity determining unit 144 sets the support necessity flag to 0 (step S118). On the other hand, as a result of the determination at the step S117, when it is determined that the current vehicle speed V is not smaller than the second reference speed V2 (step S117: No), the support necessity determining unit 144 determines that the display 143 should keep displaying the support information. Namely, the support necessity determining unit 144 determines that the display 143 should not terminate the displaying of the support information. Therefore, the support necessity determining unit 144 keeps the support necessity flag in 1 (step S119).

Then, the passing support unit 142 determines whether or not the support necessity flag that is set by the support necessity determining unit 144 is 1 (step S120). Namely, the passing support unit 142 determines whether or not the support necessity determining unit 144 determines that the display 143 should display the support information.

As a result of the determination at the step S120, when it is determined that the support necessity flag is 1 (step S120: Yes), the passing support unit 142 generates the support information (step S121). When the passing support unit 142 is already generating the supporting information at the timing when it is determined that the support necessity flag is 1, the passing support unit 142 keeps generating the supporting information without change. When the passing support unit 142 is not generating the supporting information at the timing when it is determined that the support necessity flag is 1, the passing support unit 142 starts to generate the supporting information. Moreover, the display 143 displays the support information that is generated by the passing support unit 142 (step S121). When the display 143 is already displaying the supporting information at the timing when it is determined that the support necessity flag is 1, the display 143 keeps displaying the supporting information without change. When the display 143 is not displaying the supporting information at the timing when it is determined that the support necessity flag is 1, the display 143 starts to display the supporting information.

On the other hand, as a result of the determination at the step S120, when it is determined that the support necessity flag is not 1 (step S120: No), the passing support unit 142 does not generate the support information (step S122). When the passing support unit 142 is not generating the supporting information at the timing when it is determined that the support necessity flag is not 1, the passing support unit 142 keeps to be in a state where the passing support unit 142 does not generate the supporting information without change. When the passing support unit 142 is already generating the supporting information at the timing when it is determined that the support necessity flag is not 1, the passing support unit 142 terminates the generation of the supporting information. Moreover, the display 143 does not display the support information (step S122). When the display 143 is not displaying the supporting information at the timing when it is determined that the support necessity flag is not 1, the display 143 keeps to be in a state where the display 143 does not display the supporting information without change. When the display 143 is already displaying the supporting information at the timing when it is determined that the support necessity flag is not 1, the display 143 terminates the displaying of the supporting information.

Then, the passing support unit 142 determines whether or not the signal passing support operation is terminated (step S123). For example, when the execution condition under which the signal passing support operation is allowed to be performed is not satisfied, the passing support unit 142 determines that the signal passing support operation is terminated. For example, the driver requires the termination of the signal passing support operation, the passing support unit 142 determines that the signal passing support operation is terminated

As a result of the determination at the step S123, when it is determined that the signal passing support operation is terminated (step S123: Yes), the signal passing support apparatus 14 terminates the signal passing support operation in FIG. 2. As a result, the support information is not displayed to the driver any more. In this case, the signal passing support apparatus 14 may start the signal passing support operation in FIG. 2 again after a predetermined period elapses. On the other hand, as a result of the determination at the step S123, when it is determined that the signal passing support operation is not terminated (step S123: No), the signal passing support apparatus 14 repeats processes after step S111 again.

(3) Technical Effect of Signal Passing Support Operation

As described above, in the present embodiment, the displaying of the support information is started when it is determined that the vehicle speed V is larger than the first reference speed V1 under the situation where the display 143 does not display the support information. Moreover, the displaying of the support information is terminated when it is determined that the vehicle speed V is smaller than the second reference speed V2 under the situation where the display 143 displays the support information. Namely, the signal passing support apparatus 14 uses the first reference value V1 that is compared with the vehicle speed V1 to determine whether to start the displaying of the support information and the second reference value V2 that is compared with the vehicle speed V1 to determine whether to terminate the displaying of the support information separately and independently. Thus, the signal passing support apparatus 14 is capable of appropriately securing the opportunity to display the support information while reducing the annoyance of the driver that is caused by the displaying of the support information, compared to a signal passing support apparatus in a comparison example in which a reference speed that is compared with the vehicle speed V to determine whether to start the displaying of the support information is same as a reference speed that is compared with the vehicle speed V to determine whether to terminate the displaying of the support information.

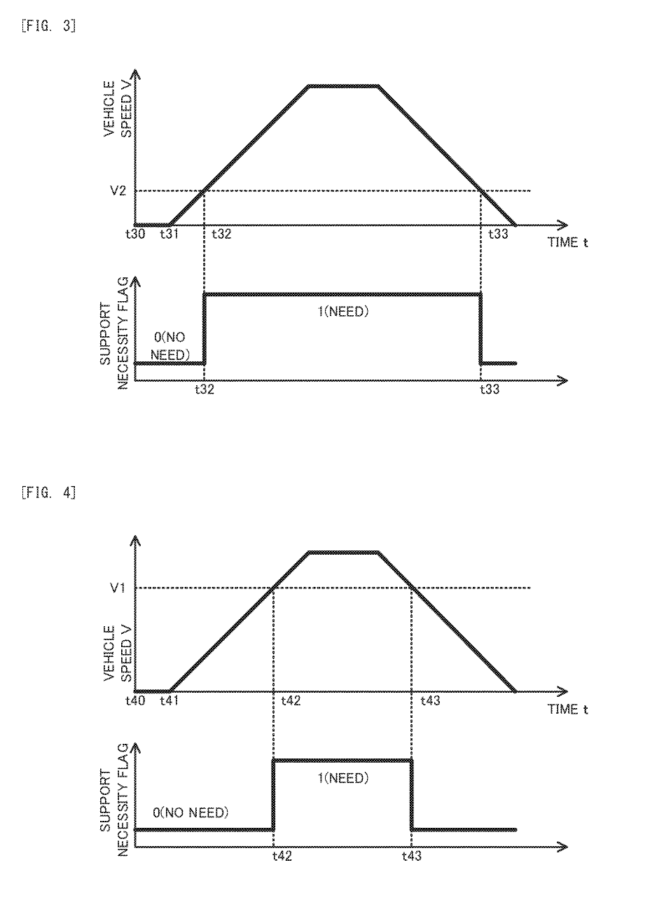

Hereinafter, with reference to FIG. 3 to FIG. 5, a technical effect of the signal passing support operation in the present embodiment will be explained. Hereinafter, in order to clearly explain the technical effect of the signal passing support operation in the present embodiment, technical problems that occur in a signal passing support operation performed by a signal passing support apparatus in a first comparison example and a signal passing support operation performed by a signal passing support apparatus in a second comparison example will be explained first, and then, the technical effect of the signal passing support operation in the present embodiment will be explained. Note that the signal passing support operation in the first comparison example is different from the signal passing support operation in the present embodiment in that the displaying of the support information is started when it is determined that the vehicle speed V is larger than the second reference speed V2 under the situation where the display 143 does not display the support information and the displaying of the support information is terminated when it is determined that the vehicle speed V is smaller than the second reference speed V2 under the situation where the display 143 displays the support information. The signal passing support operation in the second comparison example is different from the signal passing support operation in the present embodiment in that the displaying of the support information is started when it is determined that the vehicle speed V is larger than the first reference speed V1 under the situation where the display 143 does not display the support information and the displaying of the support information is terminated when it is determined that the vehicle speed V is smaller than the first reference speed V1 under the situation where the display 143 displays the support information.

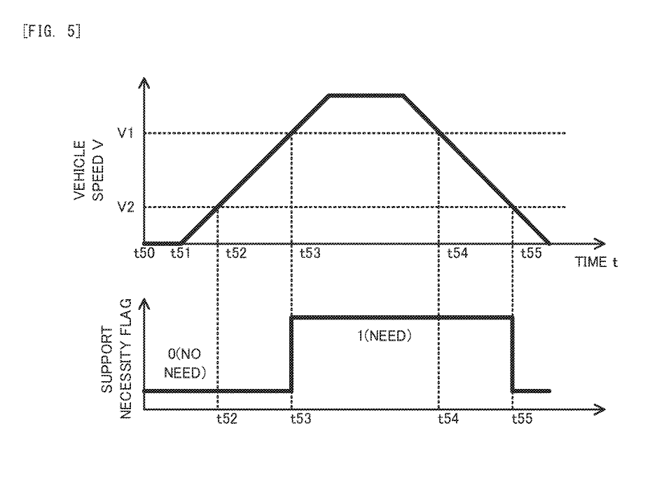

FIG. 3 is a timing chart that illustrates the vehicle speed V and the support necessity flag that is set by the signal passing support operation in the first comparison example when the vehicle 1 runs in a virtual running aspect by which the vehicle 1 firstly stops, then starts to run, then accelerates, then run in a constant speed, then decelerates and then stops. Note that the virtual running aspect in FIG. 3 is used for the purpose of explaining each of the support necessity flag that is set when the vehicle 1 is stopping, the support necessity flag that is set when the vehicle 1 is accelerating, the support necessity flag that is set when the vehicle 1 is running in the constant speed and the support necessity flag that is set when the vehicle 1 is decelerating. Namely, the virtual running aspect in FIG. 3 is not necessarily represent an actual running aspect of the vehicle 1 until the vehicle 1 reaches the traffic signal 2. FIG. 4 and FIG. 5 describe a similar situation.

As illustrated in FIG. 3, the vehicle 1 that has stopped starts the signal passing support operation at a time t30. In this case, the support necessity flag is 0 that is the initial value at the time t30. Therefore, the support information is not displayed. Then, the vehicle 1 that has stopped starts to run at a time t31. Then, the vehicle 1 accelerates, and as a result, the vehicle speed V becomes larger than the second reference speed V2 at a time t32. In this case, the support necessity flag is set to 1. Therefore, the displaying of the support information is started at the time t32. Then, the vehicle 1 accelerates, then runs in the constant speed, then decelerates, and as a result, the vehicle speed V becomes smaller than the second reference speed V2 at a time t33. In this case, the support necessity flag is set to 0. Therefore, the displaying of the support information is terminated at the time 33.

According to the above described signal passing support operation in the first comparison example, the driver may be annoyed by the support information that is displayed when the vehicle speed V that has been smaller than the second reference speed V2 becomes larger than the second reference speed V2, which is a technical problem. Specifically, since the second reference speed V2 is smaller than the first reference speed V1, there is a relatively high possibility that the vehicle 1 does not accelerate sufficiently yet immediately after the vehicle speed V becomes larger than the second reference speed V2. The possibility that the vehicle 1 does not accelerate sufficiently yet becomes larger as the second reference speed V2 is smaller. There is a possibility that the driver does not intend to pass through the traffic signal 2 yet when the vehicle 1 does not accelerate sufficiently yet. Thus, if the support information is displayed in this case, the driver may feel that the support information for supporting the vehicle 1 to pass through the traffic signal 2 is undesirably displayed even though the driver does not intend to pass through the traffic signal 2. As a result, the undesirable displaying of the support information may annoy the driver. Alternatively, when the vehicle 1 does not accelerate sufficiently yet, there is a relatively high possibility that the driver intend to further accelerate the vehicle 1. Thus, if the support information indicating that the current vehicle speed V allows the vehicle 1 to pass through the traffic signal 2 without stopping (namely, the support information substantially requiring the driver not to change the vehicle speed V in order to pass through the traffic signal 2) is displayed, the driver may feel that the support information requires the driver to maintain the vehicle speed V even though the driver wants to accelerate the vehicle 1 more. As a result, the displaying of the support information that is contradictory to the driver's intention may annoy the driver. Moreover, if the driver stops the acceleration of the vehicle 1 in response to the support information, the vehicle 1 may block the smooth running of another vehicle, because the vehicle 1 does not accelerate sufficiently yet.

Next, FIG. 4 is a timing chart that illustrates the vehicle speed V and the support necessity flag that is set by the signal passing support operation in the second comparison example when the vehicle 1 runs in the above described virtual running aspect. As illustrated in FIG. 4, the vehicle 1 that has stopped starts the signal passing support operation at a time t40. In this case, the support necessity flag is 0 that is the initial value at the time t40. Therefore, the support information is not displayed. Then, the vehicle 1 that has stopped starts to run at a time t41. Then, the vehicle 1 accelerates, and as a result, the vehicle speed V becomes larger than the first reference speed V1 at a time t42. In this case, the support necessity flag is set to 1. Therefore, the displaying of the support information is started at the time t42. Then, the vehicle 1 accelerates, then runs in the constant speed, then decelerates, and as a result, the vehicle speed V becomes smaller than the first reference speed V1 at a time t43. In this case, the support necessity flag is set to 0. Therefore, the displaying of the support information is terminated at the time 43.

According to the above described signal passing support operation in the second comparison example, an opportunity to display the support information decreases, which is a technical problem. Specifically, in the signal passing support operation in the second comparison example, the first reference speed V1 that is relatively large is used as a threshold value to determine whether to start and terminate the displaying of the support information. Therefore, in the signal passing support operation in the second comparison example, it is more likely to be determined that the vehicle speed V is smaller than the threshold value, compared to the signal passing support operation in the first comparison example in which the second reference speed V2 that is relatively small is used as the threshold value. Since the support information is not displayed when the vehicle speed V is smaller than the threshold value, the opportunity to display the support information decreases.

Note that the second reference speed V1 that is relatively small is used as a threshold value to determine whether to start and terminate the displaying of the support information in the signal passing support operation in the first comparison example. Therefore, in the signal passing support operation in the first comparison example, it is more likely to be determined that the vehicle speed V is larger than the threshold value, compared to the signal passing support operation in the second comparison example. Thus, it is possible to secure proper opportunity to display the support information. However, the signal passing support operation in the first comparison example is not capable of securing the opportunity to display the support information while reducing the annoyance of the driver caused by displaying of the support information.

In the signal passing support operation in the second comparison example, since the first reference speed V1 is relatively large, there is a relatively high possibility that the vehicle 1 has already accelerated sufficiently when the vehicle speed V is larger than the first reference speed V1. There is a possibility that the driver intends to pass through the traffic signal 2 when the vehicle 1 has already accelerated sufficiently. Thus, even when the support information is displayed, there is small or less possibility that the support information annoys the driver. Alternatively, when the vehicle 1 has already accelerated sufficiently, there is a relatively high possibility that the driver does not intend to further accelerate the vehicle 1. Thus, even when the support information indicating that the current vehicle speed V allows the vehicle 1 to pass through the traffic signal 2 without stopping is displayed, there is small or less possibility that the support information annoys the driver. However, the signal passing support operation in the second comparison example is not capable of reducing the annoyance of the driver caused by the displaying of the support information while securing the opportunity to display the support information.

Unlike the above described signal passing support operation in the first or second comparison example, the signal passing support operation in the present embodiment is capable of reducing the annoyance of the driver caused by the displaying of the support information while securing the opportunity to display the support information. Next, the technical effect of the signal passing support operation in the present embodiment will be explained.

FIG. 5 is a timing chart that illustrates the vehicle speed V and the support necessity flag that is set by the signal passing support operation in the present embodiment when the vehicle 1 runs in the above described virtual running aspect. As illustrated in FIG. 5, the vehicle 1 that has stopped starts the signal passing support operation at a time t50. In this case, the support necessity flag is 0 that is the initial value at the time t50. Therefore, the support information is not displayed. Then, the vehicle 1 that has stopped starts to run at a time t51.

Then, the vehicle 1 accelerates, and as a result, the vehicle speed V becomes larger than the second reference speed V2 that corresponds to the relatively small threshold value at a time t 52. Even in this case, the vehicle speed V is still smaller than the first reference speed V1 that corresponds to the relatively large threshold value. Thus, the support necessity flag is still 0. Therefore, the support information is not displayed. As a result, in the signal passing support operation in the present embodiment, the support information is less likely to be displayed when the vehicle 1 does not accelerate sufficiently yet, compared to the signal passing support operation in the first comparison example. Thus, it is possible to reduce the annoyance of the driver that is caused by the displaying of the support information when the vehicle 1 does not accelerate sufficiently yet.

Then, the vehicle 1 further accelerates, and as a result, the vehicle speed V becomes larger than the first reference speed V1 that corresponds to the relatively large threshold value at a time t53. In this case, the support necessity flag is set to 1. Therefore, the displaying of the support information is started at the time t53. There is a high possibility that the vehicle 1 has already accelerated sufficiently at the time t53. Therefore, even when the support information is displayed at the time t53, there is a small or less possibility that the displaying of the support information annoys the driver.

Then, the vehicle 1 accelerates, then runs in the constant speed, then decelerates, and as a result, the vehicle speed V becomes smaller than the first reference speed V1 at a time t54. Even in this case, the vehicle speed V is still larger than the second reference speed V2 that corresponds to the relatively small threshold value. Thus, the support necessity flag is still 1. Therefore, the support information continues to be displayed. Thus, the opportunity to display the support information is appropriately secured. Namely, the decrease of the opportunity to display the support information (especially, the opportunity to display the support information when the vehicle 1 decelerates) is suppressed.

One example of a situation where the vehicle 1 that runs toward the traffic signal 2 decelerates is a situation where the vehicle 1 runs toward the traffic signal 2 whose color is the red color. In this case, the vehicle 1 decelerates to some extent, and as a result, it is assumed that the vehicle speed V becomes smaller than the first reference speed V1 and allows the vehicle 1 to pass through the traffic signal 2 without stopping. In this case, the signal passing support operation in the second comparison example does not display the support information for indicating that the current vehicle speed V allows the vehicle 1 to pass through the traffic signal 2 without stopping. Therefore, there is a possibility that the vehicle 1 that runs toward the traffic signal 2 whose color is the red color decelerates more. However, the signal passing support operation in the present embodiment displays the support information for indicating that the current vehicle speed V allows the vehicle 1 to pass through the traffic signal 2 without stopping. Therefore, undesired deceleration of the vehicle 1 is suppressed. The suppression of the undesired deceleration of the vehicle 1 is one example of the technical effect that is achieved by appropriately securing the opportunity to display the support information.

Then, the vehicle 1 further decelerates, and as a result, the vehicle speed V becomes smaller than the second reference speed V2 at a time t55. In this case, the support necessity flag is set to 0. Therefore, the displaying of the support information is terminated at the time 55.

As described above, the signal passing support operation in the present embodiment is capable of appropriately reducing the annoyance of the driver caused by the displaying of the support information. The technical effect that is capable of reducing the annoyance is significant especially when the vehicle 1 accelerates. Moreover, the signal passing support operation in the present embodiment is capable of appropriately securing the opportunity to display the support information. The technical effect that is capable of securing the opportunity to display the support information is significant especially when the vehicle 1 decelerates. Thus, the signal passing support operation in the present embodiment is capable of reducing the annoyance of the driver caused by the displaying of the support information while securing the opportunity to display the support information.

Moreover, in the present embodiment, the first reference speed V1 and the second reference speed V2 are used separately and independently. Thus, when the vehicle 1 runs so that the vehicle speed V increases and decreases repeatedly, the start of the displaying of the support information and the termination of the displaying of the support information are not repeated relatively frequently. For example, the start of the displaying of the support information and the termination of the displaying of the support information are not repeated relatively frequently, when the vehicle 1 runs on a congested road. As a result, it is also possible to reduce the annoyance of the driver caused by the frequent repetition of the start of the displaying of the support information and the termination of the displaying of the support information.

Note that the above described technical effect that is capable of reducing the annoyance of the driver caused by the displaying of the support information is mainly realized by determining on the basis of the first reference speed V1 whether to start the displaying of the support information. On the other hand, the above described technical effect that is capable of securing the opportunity to display the support information is mainly realized by determining on the basis of the second reference speed V2 whether to terminate the displaying of the support information. Moreover, achieving both technical effects is mainly realized by making the first reference speed V1 and the second reference speed V2 to be different from each other. Thus, it is preferable that each of the first reference speed V1 and the second reference speed V2 be set to an appropriate value that is capable of appropriately achieving both technical effects. For example, the first reference speed V1 may be set to an appropriate value that is capable of distinguishing a situation where the vehicle 1 has already accelerated sufficiently and a situation where the vehicle 1 does not accelerate sufficiently yet. The second reference speed V2 may be set to an appropriate value that is capable of distinguishing a situation where the vehicle speed V is small to an extent that the driver does not intend to pass through the traffic signal 2 (as a result, the driver does not need the displaying of the support information) and a situation where the vehicle speed V is not small to the extent the driver does not intend to pass through the traffic signal 2 (as a result, the driver may need the displaying of the support information). For example, the first reference speed V1 may be set to a value that is larger by 10 km/h to 20 km/h than the second reference speed V2.

In the above described embodiment, the support information is displayed as an image by the display 143. However, the support information may be outputted as audio by a speaker. Alternatively, the support information may be outputted in any output aspect by which the driver can recognize the support information.

The above-described exemplary embodiments can be modified without departing from the essence or spirit of the overall description which can be read from the claims and the entire specification.

### REFERENCE SIGNS LIST

1 vehicle
14 signal passing support apparatus
142 passing support unit
143 display
144 support necessity determining unit

1. A signal passing support apparatus comprising:
a providing device configured to provide support information to a driver of a vehicle, the supporting information supporting the vehicle to pass through a traffic signal; and
a determining device configured to determine whether or not a vehicle speed of the vehicle is larger than a first reference speed and the vehicle speed is smaller than a second reference speed, the second reference speed being smaller than the first reference speed,
wherein
the providing device is configured to start the providing of the support information in response to determining that the vehicle speed is larger than the first reference speed under a situation where the providing device does not provide the support information,
the providing device is configured to terminate the providing of the support information in response to determining that the vehicle speed is smaller than the second reference speed, when the providing device provides the support information.

2. The signal passing support apparatus according to claim 1, wherein
the providing device is configured to refrain from providing the support information in response to determining that the vehicle speed is not larger than the first reference speed in response to the providing device refraining from providing the support information,
the providing device is configured to continue providing the support information in response to determining that the vehicle speed is not smaller than the second reference speed when the providing device provides the support information.

3. The signal passing support apparatus according to claim 1 further comprising:
a generating device configured to generate the support information during a period when the providing device provides the support information and configured not to generate the support information during a period when the providing device does not provide the support information.

4. The signal passing support apparatus according to claim 3, wherein
the generating device is configured to start the generation of the support information in response to determining that the vehicle speed is larger than the first reference speed in response to the providing device refraining from providing the support information,
the generating device is configured to terminate the generation of the support information when it is determined that the vehicle speed is smaller than the second reference speed when the providing device providing the support information.

5. The signal passing support apparatus according to claim 4, wherein
the generating device is configured to refrain from generating the support information in response to determining that the vehicle speed is not larger than the first reference speed in response to the providing device refraining from providing the support information,
the generating device is configured to keep generating the support information in response to determining that the vehicle speed is not smaller than the second reference speed when the providing device provides the support information.
